(19) United States
(12) Patent Application Publication
(10) Pub. No.: US 2026/0091667 A1
(43) Pub. Date: Apr. 2, 2026

(54) DIFFERENTIAL WITH BIDIRECTIONAL OVERRUNNING CLUTCH

(71) Applicant: TEAM Industries, Inc., Bagley, MN (US)

(72) Inventors: John Edward Hamrin, Bemidji, MN (US); Ethan Hensel, Shevlin, MN (US); Gregory Lee Maki, Solway, MN (US); Jordan Murphy, Bemidji, MN (US); Ryan Thomas Held, Bemidji, MN (US)

(73) Assignee: TEAM Industries, Inc., Bagley, MN (US)

(21) Appl. No.: 19/335,161

(22) Filed: Sep. 22, 2025

Related U.S. Application Data
(60) Provisional application No. 63/701,303, filed on Sep. 30, 2024.

(51) Int. Cl. B60K 17/02; B60K 17/16; F16D 7/00; F16D 23/12; F16H 37/08; F16H 48/20

(52) U.S. Cl. CPC B60K 17/02; B60K 17/165; F16D 7/007; F16D 23/12; F16H 37/0813; F16H 48/20; F16D 2023/123; F16H 2048/202

(57) ABSTRACT

A differential with an always actuated overrunning clutch (ORC) is provided. The differential includes a first plain bearing end cap with an interior surface that forms a plain bearing interface with an outer surface of a first side hub. The first plain bearing end cap further has a first outer surface portion that engages a first end portion of a roller cage assembly. A second plain bearing end cap with an interior surface that forms a plain bearing interface with an outer surface of the second side hub is also included. The second plain bearing end cap further has a first outer surface portion that engages a second end portion of the roller cage assembly. The always actuated ORC engages the roller cage assembly during an ORC condition to couple torque between a ring gear and the first and second side hubs.

This application claims priority to U.S. Provisional Application Ser. No. 63/701,303, same title herewith, filed on Sep. 30, 2024, which is incorporated in its entirety herein by reference.

### BACKGROUND

Vehicle differentials transfer torque between a driveshaft and driven shafts (or half shafts). A differential allows the half shafts to rotate at different rotational speeds with relation to each other when a vehicle turns to prevent tire scrubbing, reduce transmission loads and reduce under-steering during cornering (the tendency of the vehicle to go straight in a corner). In four-wheel drive applications, bi-directional overrunning clutches have been employed in differentials to transmit torque to the wheel via the half shafts when needed. For example, in a front differential example, the front differential is designed to transfer torque when the rear wheels are rotating faster than the front wheels.

Current designs typically require the operator to activate a bi-directional overrunning clutch. One method of selectively activating a bidirectional overrunning clutch is by selectively activating a switch that energizes an electromagnetic coil. The energized electromagnetic coil typically manipulates an overrunning clutch armature plate to engage a roller cage to activate the bidirectional overrunning clutch.

For the reasons stated above and for other reasons stated below which will become apparent to those skilled in the art upon reading and understanding the present specification, there is a need in the art for a cost effective and efficient differential with a bidirectional overrunning clutch that does not need to be selectively activated.

### SUMMARY

The following summary is made by way of example and not by way of limitation. It is merely provided to aid the reader in understanding some of the aspects of the subject matter described. Embodiments provide a cost effective differential with a bidirectional always actuated ORC.

In one embodiment, a differential is provided that includes a housing, a cover coupled to the housing, a first side hub and second side hub, a pinion gear, roller cage, a clutch cam housing, a centering spring, and an always actuated ORC. The first and second side hubs are received within the housing. The ring gear is also received within the housing. The pinion gear is in operational engagement with the ring gear. The pinion gear is configured to couple torque between the ring gear and a transmission. The roller cage includes rollers that engage a first roller engaging outer surface portion of the first side hub and a second roller engaging outer surface portion of the second side hub. The clutch cam housing is received around the roller cage. The clutch cam housing is operationally coupled to the ring gear. The clutch cam housing further has an internal surface with cam features. The rollers of the roller cage are positioned to engage the cam features in an interior surface of the clutch cam housing to selectively couple torque between the ring gear and the first and second side hubs. The centering spring is positioned to provide a centering force between the roller cage and the clutch cam housing to center the rollers of the roller cage in associated cam features in the interior surface of the clutch cam housing. The always actuated ORC is configured to engage the roller cage during an ORC condition to provide a torsion force to overcome the centering force provided by the centering spring therein allowing the rollers of the roller cage to selectively couple torque between the ring gear and at least one of the first and second side hubs.

In another example, another differential is provided that includes a housing, a cover coupled to the housing, a first side hub, a second side hub, a ring gear received within the housing, a pinion gear, a roller cage, a clutch cam housing, a centering spring, a first plain bearing end cap, a second plain bearing end cap, an always actuated ORC. The first and second side hubs are received within the housing. The pinion gear is in operational engagement with the ring gear. The pinion gear is configured to couple torque between the ring gear and a transmission. The roller cage includes rollers that engage a first roller engaging outer surface portion of the first side hub and a second roller engaging outer surface portion of the second side hub. The clutch cam housing is received around the roller cage. The clutch cam housing is operationally coupled to the ring gear. The clutch cam housing further has an internal surface with cam features. The rollers of the roller cage are positioned to engage the cam features in an interior surface of the clutch cam housing to selectively couple torque between the ring gear and the first and second side hubs. The centering spring is positioned to provide a centering force between the roller cage assembly and the clutch cam housing to center the rollers of the roller cage assembly in associated cam features in the interior surface of the clutch cam housing. The first plain bearing end cap has an interior surface that forms a plain bearing interface with a first end cap engaging outer surface portion of the first side hub. The first plain bearing end cap further has a first outer surface portion that engages a first end portion of the roller cage assembly. The second plain bearing end cap has an interior surface forming a plain bearing interface with a second end cap engaging outer surface portion of the second side hub. The second plain bearing end cap further has a first outer surface portion that engages a second end portion of the roller cage assembly. The first and second plain bearing end caps support a positional location of the roller cage assembly. The always actuated ORC is configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

In another example, a vehicle is provided. The vehicle includes an engine to generate torque, a CVT, and differential. The CVT is in operational communication with the engine. The differential is in operational engagement with the CVT. The differential includes a housing, a cover coupled to the housing, a first side hub, a second side hub, a ring gear, a pinion gear, a roller cage assembly, a clutch cam housing, a centering spring, and an always activated ORC. The first and second side hubs are received within the housing. The ring gear is received within the housing. The pinion gear is in operational engagement with the ring gear. The pinion gear is configured to couple torque between the ring gear and a transmission. The roller cage assembly includes rollers that engage a first roller engaging outer surface portion of the first side hub and a second roller engaging outer surface portion of the second side hub. The clutch cam housing is received around the roller cage assembly. The clutch cam housing is operationally engaged with the ring gear, the clutch cam housing further have an internal surface with cam features. The rollers of the roller cage assembly are positioned to engage the cam features in an interior surface of the clutch cam housing to selectively couple torque between the ring gear and the first and second side hubs. The centering spring is positioned to provide a centering force between the roller cage assembly and the clutch cam housing to center the rollers of the roller cage assembly in associated cam features in the interior surface of the clutch cam housing. The always actuated ORC is configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

### BRIEF DESCRIPTION OF THE DRAWINGS

The present invention can be more easily understood and further advantages and uses thereof will be more readily apparent, when considered in view of the detailed description and the following figures in which:

FIG. 1 is an unassembled view of a differential with an always actuated bidirectional overrunning clutch according to an example aspect of the present invention;

FIG. 2 is a cross-sectional view of the differential and always actuated bidirectional overrunning clutch of FIG. 1;

FIG. 3 is a partial close up cross-sectional view of the always actuated bidirectional overrunning clutch of FIG. 1;

FIG. 4A illustrates a first end perspective view of a partial assembled always actuated bidirectional overrunning clutch of FIG. 1;

FIG. 4B illustrates a side view of a partial assembled always actuated bidirectional overrunning clutch of FIG. 1;

FIG. 4C illustrates a second end perspective view of a partial assembled always actuated bidirectional overrunning clutch of FIG. 1;

FIG. 5A illustrates a second end perspective view of a partial assembled always actuated bidirectional overrunning clutch of FIG. 1;

FIG. 5B illustrates a second end perspective view of a partial assembled always actuated bidirectional overrunning clutch of FIG. 1;

FIG. 5C illustrates a first end perspective view of a partial assembled always actuated bidirectional overrunning clutch of FIG. 1;

FIG. 6 illustrates a cross-sectional side view of another differential with another always actuated bidirectional overrunning clutch according to an example aspect of the present invention;

FIG. 7 is a partial close up cross-sectional view of the always actuated bidirectional overrunning clutch of FIG. 6;

FIG. 8 is a perspective view of an inside of a cover of the differential of FIG. 6;

FIG. 9 is a side perspective view of a slotted disk spring of the always actuated bidirectional overrunning clutch of FIG. 6;

FIG. 10 is a side perspective cross-sectional view of a partial assembled always actuated bidirectional overrunning clutch of FIG. 6;

FIG. 11 is a side perspective view of a drag plate of the always actuated bidirectional overrunning clutch of FIG. 6;

FIG. 12 is a side perspective view of an armature plate of the always actuated bidirectional overrunning clutch of FIG. 6;

FIG. 13 is an unassembled side view of another differential with another always actuated bidirectional overrunning clutch according to an example aspect of the present invention;

FIG. 14 is an assembled differential with the always actuated bidirectional overrunning clutch of FIG. 13;

FIG. 15 is a partial close up cross-sectional view of the always actuated bidirectional overrunning clutch of FIG. 13;

FIG. 16 is a side perspective view of a partial assembled always actuated bidirectional overrunning clutch of FIG. 13;

FIG. 17 is a side view of a partial assembled always actuated bidirectional overrunning clutch of FIG. 13;

FIG. 18 is a perspective side view of a partial assembled always actuated bidirectional overrunning clutch of FIG. 13;

FIG. 19 is a side perspective view of a roller cage assembly of the always actuated bidirectional overrunning clutch of FIG. 13; and

FIG. 20 is a block diagram of a vehicle having a front differential with an always actuated bidirectional overrunning clutch.

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings, which form a part hereof, and in which is shown by way of illustration specific embodiments in which the inventions may be practiced. These embodiments are described in sufficient detail to enable those skilled in the art to practice the invention, and it is to be understood that other embodiments may be utilized and that changes may be made without departing from the spirit and scope of the present invention. The following detailed description is, therefore, not to be taken in a limiting sense, and the scope of the present invention is defined only by the claims and equivalents thereof.

Embodiments of the present invention provide a differential with a bidirectional always actuated overrunning clutch (ORC). In an example, the always actuated ORC is located in a front differential. This example provides a simple all-wheel drive (AWD) system that is capable of putting full torque to any wheel as needed in a cost efficient manner. Moreover, an automatic all-terrain AWD is provided that is full torque capable to either front wheel without an electrical system that would require wires, switches, and an electrical current load. Since the front final drive is a bidirectional “always actuated” (always on) ORC, the ability to have an all-wheel drive (AWD) vehicle that requires no user knowledge or intervention (i.e., no switching between actuated and not actuated is required).

An always actuated configuration may be accomplished by keeping a coil on all the time. This would provide constant friction. However, an always on coil configuration carries unnecessary costs, complexity, as well as added potential failure points in an ORC system. In embodiments of the present invention, a selectable coil actuation configuration known in the art is replaced by a constant friction, always actuated configuration. In examples, a constant frictional torque between the roller cage assembly and ground results in the roller cage assembly always being rotationally retarded from its neutral position as defined relative to a clutch cam housing.

Although the always actuated ORC is described below as being a front differential, the always actuated ORC may be employed in other differentials including, but not limited to, rear and center differentials. Further, the terms “coupled with” and “in operational communication with,” “in operational engagement with” along with derivations of the terms, may be used herein. These terms indicate that two or more elements are interacting with each other. The interaction may be physical or non-physical. Physical interaction includes physical connecting of the two or more elements. Non-physical interaction includes, but are not limited to, interactions through signals, such as, but not limited to, power signals, communication signals, etc. The interaction between the two or more elements may be direct or through intermediate elements.

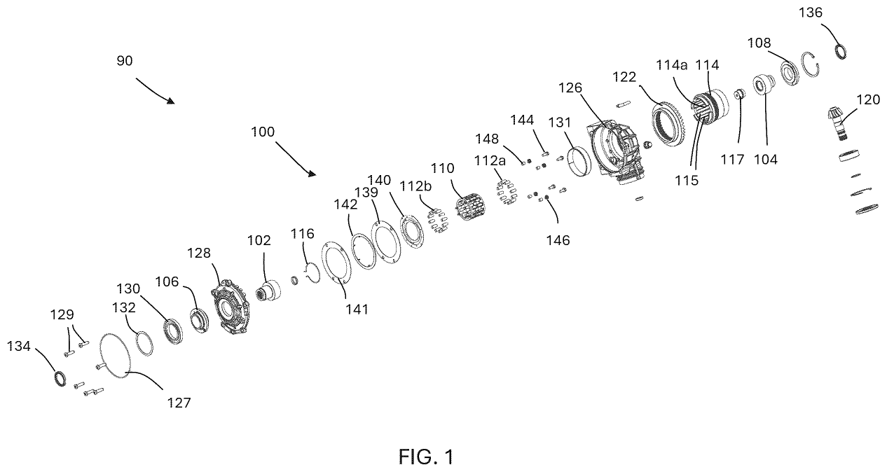

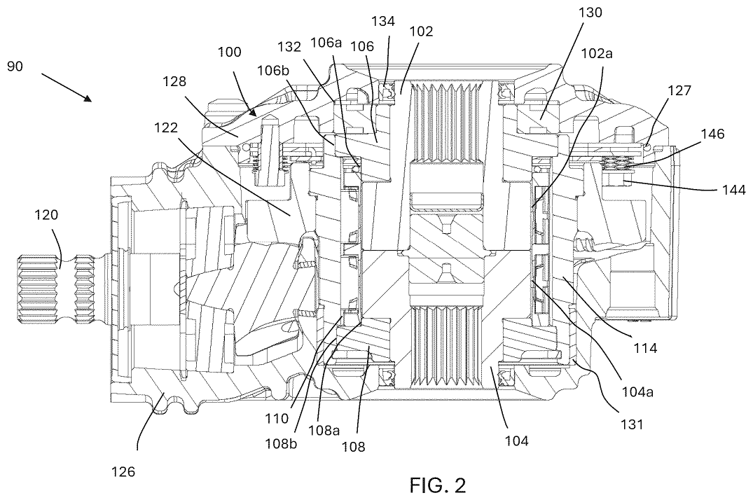

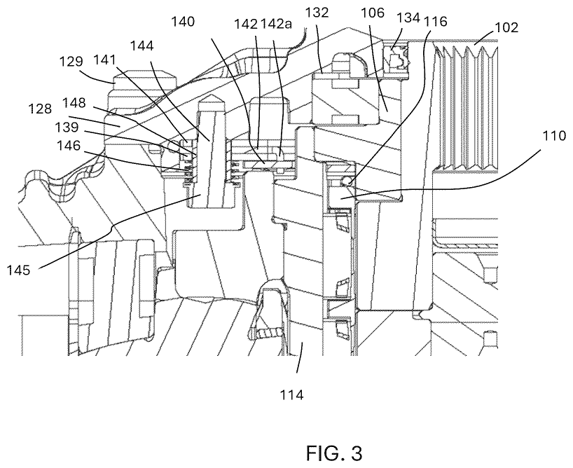

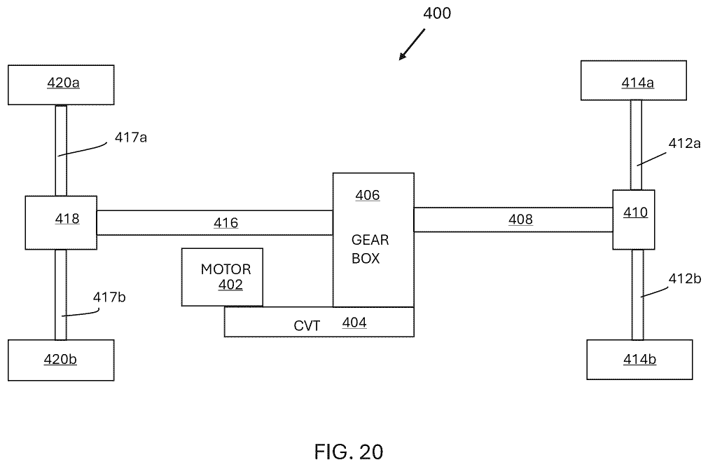

FIG. 1 illustrates an unassembled view of a differential 90 that includes an always actuated ORC 100 of an example embodiment. Referring to the unassembled view of FIG. 1 and the cross-sectional side view of FIGS. 2 and 3, the differential 90 includes a first output hub (first side hub 102) and a second output hub (second side hub 104). Central alignment hub 117 is positioned within a portion of central passages of the first side hub 102 and the second side hub 104. Each of the first side hub 102 and second side hub 104, in this example includes interior splines used to convey torque between half shafts 417a and 417b illustrated in the example vehicle block diagram of FIG. 20.

The differential 90 also includes a first end cap 106 and a second end cap 108. The first end cap 106 includes an inner surface that engages an first end cap engaging outer surface portion of the first side hub 102. Likewise, the second end cap 108 includes an inner surface that engages a second end cap engaging outer surface portion of the second side hub 104. The first end cap 106 includes a first outer shoulder portion 106a that engages a first end of a roller cage assembly 110. The second output hub 104 includes a second outer shoulder portion 108a that engages a second end of the roller cage assembly 110.

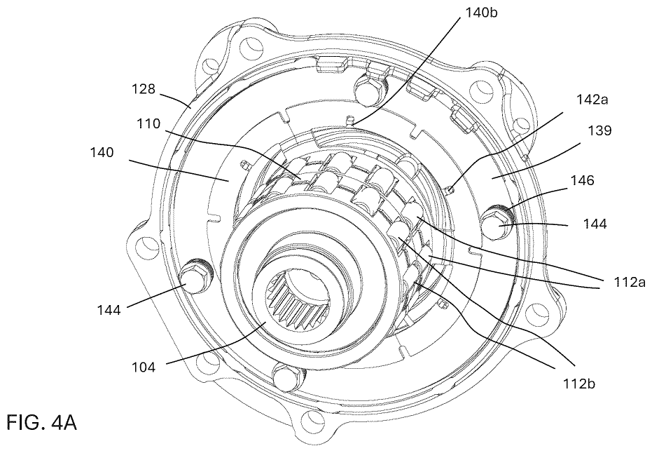

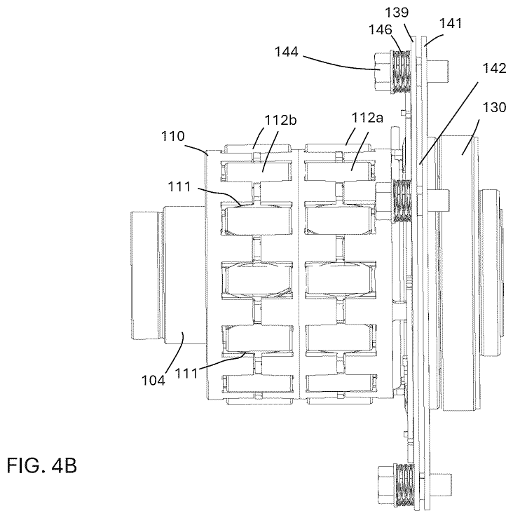

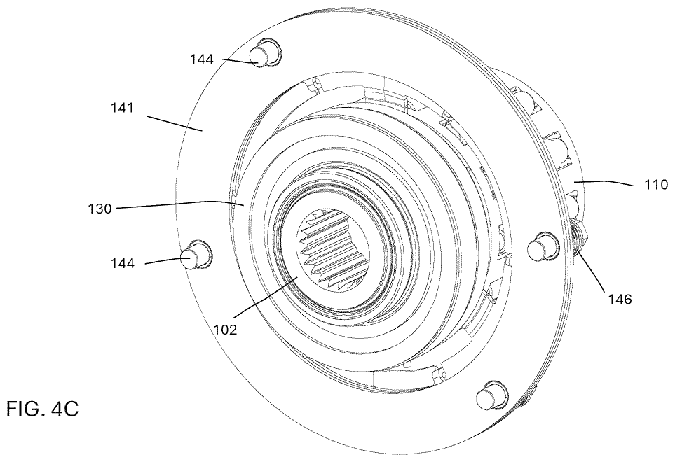

The always activated ORC 100 includes the roller cage assembly 110. A plurality of rollers are retained within a roller cage of the roller cage assembly 110. In particular in this example, a first set of rollers 112a within the roller cage assembly 110 are positioned to engage a first roller engaging outer surface portion 102a of the first output hub 102. H-springs 111, best illustrated in FIG. 4B, position each roller 112a and 112b within a slot in the roller cage assembly. A second set of rollers 112b within the roller cage assembly 110 are positioned to engage a second roller engaging outer surface portion 104a of the second output hub 104.

A clutch cam housing 114, that includes a central passage, is received around the roller cage assembly 110. The clutch cam housing 114 has a first inner end that engages an outer surface portion 106b of the first end cap 106. The clutch cam housing 114 has a second inner end that engages an outer surface portion 108b of the second end cap 108. An inner surface 114a of the clutch cam housing 114 includes a plurality of concave features 115. Rollers 112a and 112b of roller cage assembly 110 are aligned within associated features 115 of the clutch cam housing 114 with the use of a centering spring 116. In particular, centering spring 116 engages the roller cage assembly 110 to provide a centering force so the rollers 112a and 112b align in with their associated features 115 in the internal surface 114a of the clutch cam housing 114. When the rollers 112a and 112b are aligned in their respective cam features 115, the rollers do not engage the clutch cam housing 114 so no torque is transferred between the clutch cam housing 114 and the first and second output hubs 102 and 104.

When one of the clutch cam housing 114, the first output hub (first side hub 102) and the second output hub (second side hub 104), tries to overrun one of the other of the clutch cam housing 114, the first output hub 102 and the second output hub 104, the centering force provided by the centering spring is countered causing select rollers 112a and/or 112b to move from their respective center aligning position within an associated feature 115 therein engaging the clutch cam housing 114. This allows torque to be transferred between the clutch cam housing 114 to at least one of the first output hub 102 and the second output hub 104.

The differential 90 further includes in this example a pinion (pinion gear 120). Pinion gear 120 is in operational communication with a prop shaft, such as prop shaft 416 of FIG. 20. The pinon gear 120 is engaged with a ring gear 122 that is in turn engaged with the clutch cam housing 114.

A housing 126 and cover 128 encases the always actuated ORC 100 of the differential 90. In one example, fasteners 129 couple the cover 128 to the housing 126. A bearing 130, which may be a ball bearing, is positioned between the cover 128 and a surface of the first end cap 106. Further in an example, a shim 132 may be positioned between bearing 130 and the cover 128. A first seal 134 is positioned between an outer surface of the first output hub 102 and the cover 128 and a second seal 136 is positioned between an outer surface of the second output hub 104 and the housing 126 (case). A plain bearing 131 is positioned between the housing 126 and an end portion of the clutch cam housing 114 as best illustrated in FIG. 2. Further an O-ring seal 127 positioned between the housing 126 and the cover 128.

Referring to FIG. 3, the always actuated ORC 100 in this example further includes a connector plate 140, a rotor plate 142, a first drag plate 139 (inboard drag plate) and a second drag plate 141 (outboard drag plate). Further illustrated in FIGS. 1 through 3 are a plurality of fasteners 144. Each fastener is received within associated passages in the first drag plate 139 and the second drag plate 141. Each fastener 144 includes head 145. An associated slotted spacer 148 and wave spring 146 is positioned around a shaft of each fastener. Each fastener 144 is further engaged in an inside surface of the cover 128. Each wave spring 146 includes a first end engaged with the head 145 of an associated fastener 144 and a second end that engages the first drag plate 139. Each wave spring 146 asserts a bias force on the first drag plate 139 to push the first drag plate 139 into the rotor plate 142 and the second drag plate 141. The second drag plate 141 abuts an inside surface of the cover 128 in this example. In particular, wave springs 146 generate a clamping force between first and second drag plates, which are stationary, and the rotor plate 142. The rotor plate 142 is operatively connected to the roller cage assembly 110 via connector plate 140.

In an example, the slotted spacers 148 align the concentricity of the rotor plate 142 for installation while also providing the structure for a spring force from the wave springs 146 to act upon the plates (i.e., the first drag plate 139, the rotor plate 142, and the second drag plate 141), creating a normal force pinching the rotor plate 142. The friction potential created by this normal force results in a drag torque on the rotor plate 142, resulting in a change in relative angle of the roller cage assembly 110 relative to the clutch cam housing 114. In another example, a shoulder bolt may be utilized to the to the same effect.

It may be desired to move a contact point off the outer edge of the rotor plate 142 to reduce wear and provide consistent friction. This may be done in one example, by coining an outer edge of the rotor plate 142. This results in moving a contact pattern off the edge of the rotor plate 142. In another example, the first drag plate 139 and the second drag plate 141 may both include opposite offset outside edge portions to move the contact pattern between the first drag plate 139, the rotor plate 142, and the second drag plate 141.

FIG. 4A, FIG. 4B and FIG. 4C illustrate perspective views of a partial assembled always actuated ORC 100 of an example. FIG. 4A illustrates a first end perspective view the fasteners 144 coupled to the cover 128, the roller cage assembly 110, the connector plate 140 and the first drag plate 139. FIG. 4B illustrates a side view of the fasteners 144, plates (the first drag plate 139, the rotor plate 142 and the second drag plate 141) and the roller cage assembly 110. FIG. 4C illustrates a second end perspective view illustrating fasteners 144, the second drag plate 141, the roller cage assembly 110 and the first hub 102.

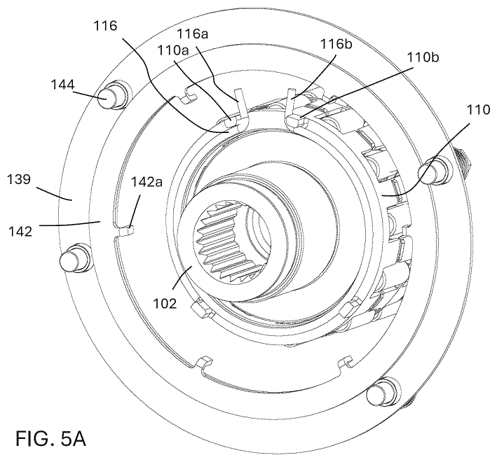

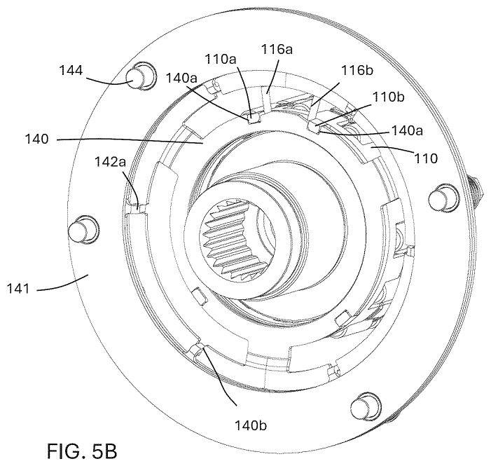

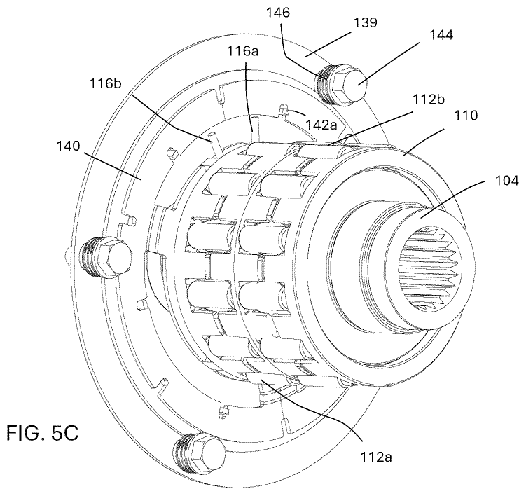

FIG. 5A illustrates a portion of the always actuated ORC 100 with the second drag plate 141 and the connector plate 140 removed so that the arrangement of the rotor plate 142, the first drag plate 139, the centering spring 116 and the roller cage assembly 110 can be seen. As illustrated, ends 116a and 116b of the centering spring 116 that extend radially outward engage tabs 110a and 110b that extend axially outward from the roller cage assembly 110. FIG. 5B illustrates a portion of the always actuated ORC 100 that includes the connector plate 140. As illustrated, connector plate 140 includes notches 140a that receive the tabs 110a and 110b of the roller cage assembly 110 to lock rotation of the connector plate 140 with the rotation of the roller cage assembly 110. Further illustrated, axially extending engaging tabs 142a of the rotor plate 142 are received in receiving slots 140b of the of the connector plate 140 to lock rotation of the connector plate 140 with the rotor plate 142.

The design illustrated in FIG. 1 through FIG. 5C allows for a cover sub-assembly to be the only difference between a coil selectable engagement design known in the art, therein allowing for many common parts and lower production costs. The cover sub-assembly can be separately built up from the rest of the differential housing and associated parts. Final assembly requires the angular alignment of the armature connector plate tabs 142a of the rotor plate 142 of the cover sub-assembly to the receiving slots 140b of the connector plate 140. The clamp force may be tuned by changing the height of the spacers 148 and or changing out the wave springs 146. Pressure distribution can be manipulated away from the edges of the plates (the first drag plate 139, the rotor plate 142 and the second drag plate 141) and for increased engagement area by shaping the plate edges as discussed above.

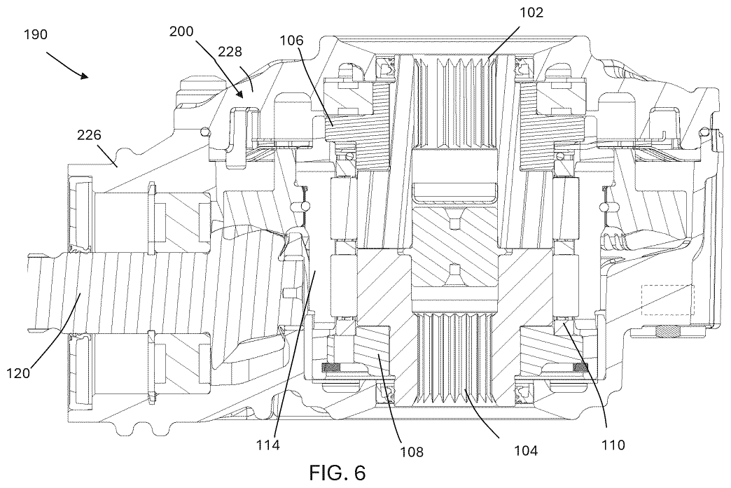

FIG. 6 illustrates a cross-sectional view of another differential 190 with another example of an always actuated ORC 200. This embodiment uses a single spring element which helps reduce components of an always actuated ORC. Just like always actuated ORC 100 discussed above, always actuated ORC 200 includes an over-running clutch mechanism that does not need an electromagnet coil to energize in order to initiate locking of the roller clutch and torque transfer to the ground. Always actuated ORC 200 is essentially “always on” and any time there is rotation of the ring gear/clutch cam housing assembly, frictional torque is applied to the armature plate, overcoming the centering force of the omega spring (centering spring 116), which allows torque to be transferred between the clutch cam housing 114 to at least one of the first output hub 102 and the second output hub 104.

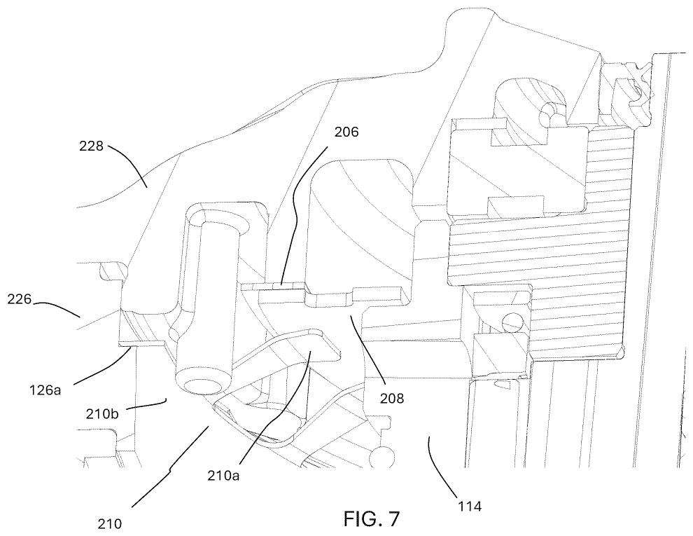

In this example, a spring element is grounded to housing 226 or cover 228, which is compressed when cover 228 is assembled to the housing 226. Spring element, which is a slotted disk spring in an example reacts against a rotor plate 208, which in turn reacts against a drag plate 206 that is grounded to the cover 228. This is best illustrated in the partial close up cross-sectional view of FIG. 7. This arrangement pinches rotor plate 208 between two grounded components, the cover 228 and a slotted disk spring 210. Any rotation of the ring gear 122 and clutch cam housing 114 results in a frictional torque being applied to the rotor plate 208.

In this example, when cover 228 is installed, the cover 228 pushes the drag plate 206 against the rotor plate 208, which in turn pushes against an inner portion (fingers 210a) of the slotted disk spring 210. An outer portion 210b of the slotted disk spring 210 reacts against a shoulder 126a of the housing 126. This arrangement pinches rotor plate 208 between the fingers 210a of the slotted disk spring 210 and the drag plate 206, creating a frictional torque on both surfaces of the rotor plate 208 when the clutch cam housing 114 is rotated. The relative motion of the rotor plate 208 relative to the clutch cam housing 114 allows torque to be transferred between the clutch cam housing 114 to at least one of the first output hub 102 and the second output hub 104.

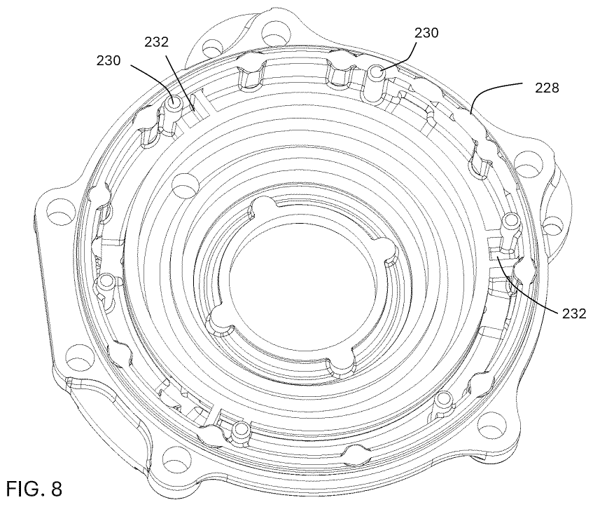

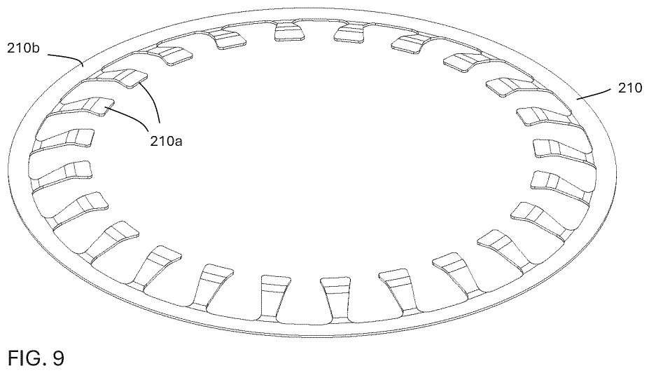

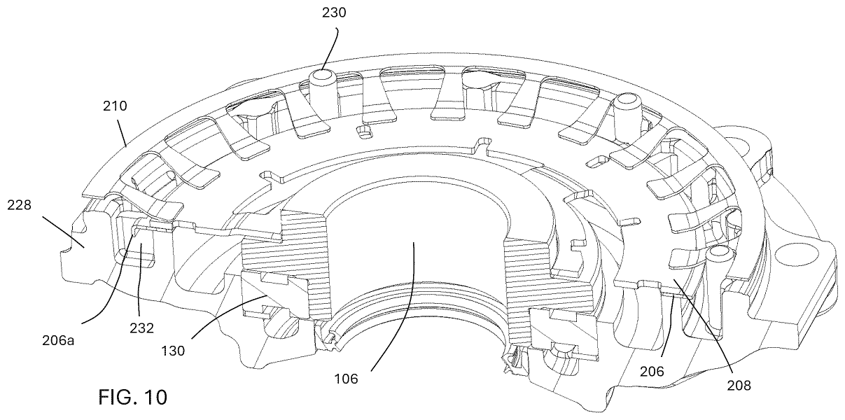

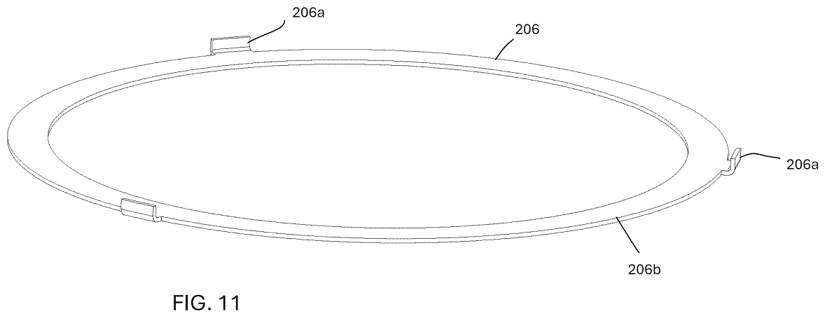

FIG. 8 illustrates an inside view of cover 228. Cover 228 includes a plurality of spaced lugs 230 that provide a spring anti-rotation/ground feature that prevents the slotted disk spring 210 from rotating. An illustration of the slotted disk spring 210 is illustrated in FIG. 9. As discussed above, the slotted disk spring 210 includes a plurality of fingers 210a that extend radially inward from an outer portion 210b. Distal ends of the fingers 210a are further axially raised from the outer portion 210b. The lugs 230 of the cover are positioned between some of the fingers 210a of the slotted disk spring 210 to limit rotation of the slotted disk spring 210 in relation to the cover 228 (ground). This is best illustrated in the cross-sectional view of cover 228 and slotted disk spring 210 of FIG. 10. As further illustrated, the distal ends of the fingers 210a of the slotted disk spring 210 engage the rotor plate 208. The drag plate 206 further includes anti-rotation tabs 206a, that are designed and positioned in cover slots 232 of the cover 228 to limit rotation of the drag plate 206 relative to the cover 228 (ground). An example of the drag plate is illustrated in FIG. 11. As illustrated, the spaced anti-rotation tabs 206a extend generally perpendicular from an outer edge of a disk shaped body 206b.

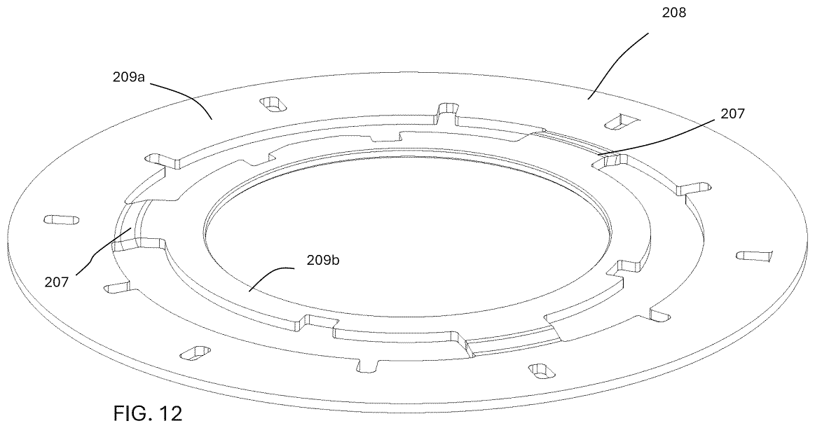

An example of rotor plate 208 is illustrated in FIG. 12. Rotor plate 208 includes, in the example, an outer disk portion 209a and an inner disk portion 209b. The inner disk portion 209b is offset from the outer disk portion 209a via connecting members 207.

In the example of FIGS. 6 through 12, when the clutch cam housing 114/ring gear 122 assembly is rotated, friction induced by an axial preload by the slotted disk spring 210 applied through the rotor plate 208 to the drag plate 206 tries to make the slotted disk spring 210 and the drag plate 206 rotate with the rotor plate 208. To arrest this motion, the anti-rotation tabs 206a of the drag plate 206, positioned within cover slots 232, lock the drag plate 206 to the cover 228 to prevent rotation of the drag plate 206 about the drag plate's axis. Other types of anti-rotation elements may be used instead of anti-rotation tabs 206a, such as but not limit to, pins and screws.

Similarly, the slotted disk spring 210 is prevented from rotation by grounding the slotted disk spring 210 to the cover 228 with the lugs 230 of the cover 228 protruding from the cover 228 between fingers 210a of the slotted disk spring 210. The example of the lugs 230 shown are cylindrical in shape. However, depending on the design of the spring slots between the fingers 210a of the slotted disk spring 210, the lugs 230 may be shaped to minimize play that would result from drive/coast direction changes. Further, other examples, may use pins, screws, etc., instead of the lugs 230. The number of anti-rotation tabs 206a on the drag plate 206 and the number of lugs 230 on the cover 228 may be adjusted depending on application needs for load magnitude.

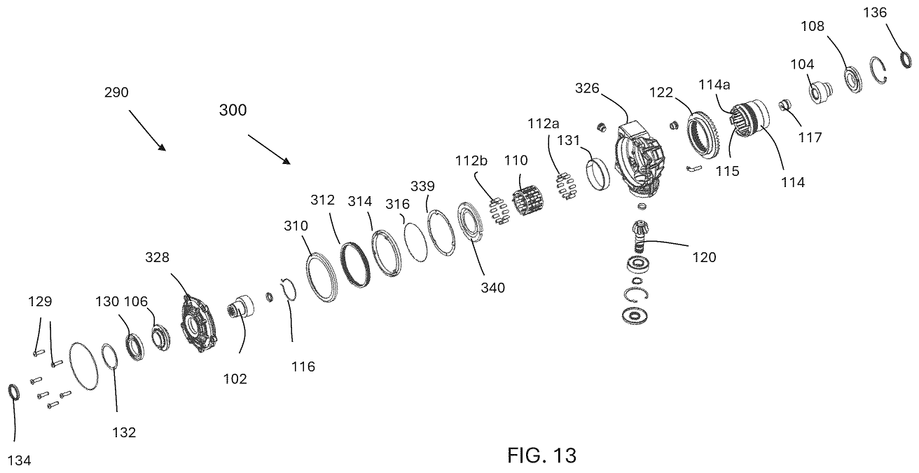

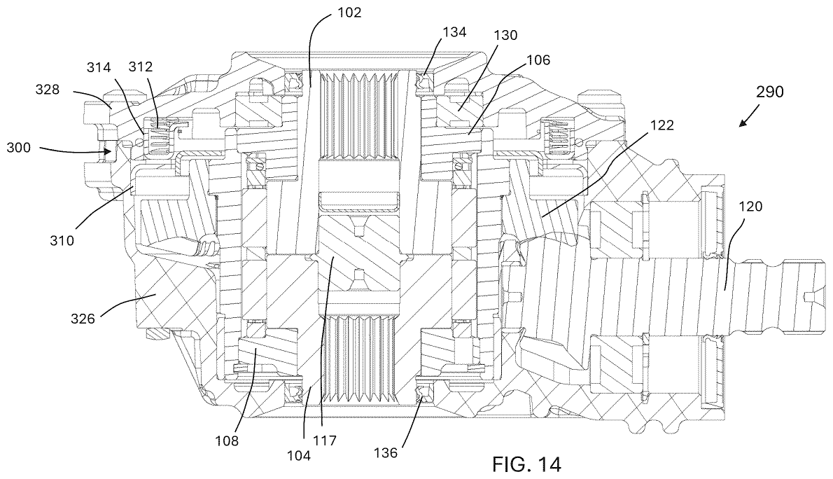

Another example embodiment of a differential 290 with another always actuated ORC 300 is illustrated in FIG. 13 through 19. FIG. 13 illustrates an unassembled view of differential 290 including the always actuated ORC 300 and FIG. 14 illustrates an assembled cross-sectional side view of differential 290 with always actuated ORC 300 contained within housing 326 and cover 328. Always actuated ORC 300 in this example uses another clamping assembly to generate a clamping force to keep the always actuated ORC 300 in an active configuration. Always actuated ORC 300 in this example includes a single wave spring 312 that is received within a spring cup 314. Always activated ORC 300 further includes a drag plate 310, a rotor plate 339, an connector plate 340 and a retaining ring 316.

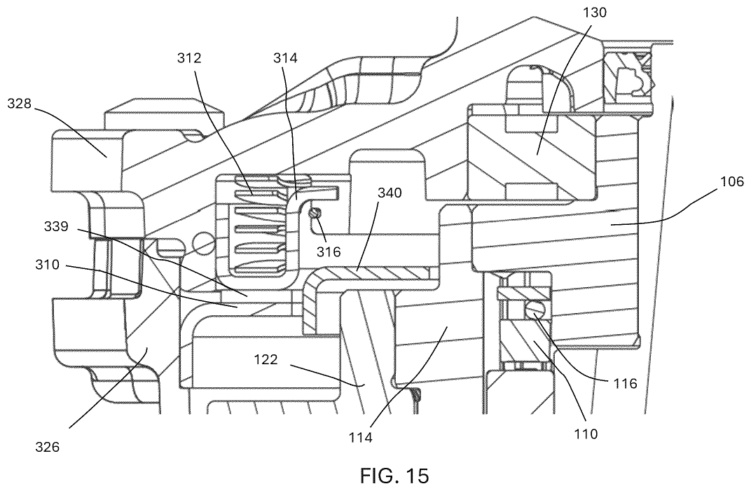

A close up cross-sectional view of a portion of the always activated ORC 300 is illustrated in FIG. 15. The wave spring 312 in the spring cup 314 exerts a clamping force on the drag plate 310 and the rotor plate 339 to engage the connector plate 340. In this example, a clamp force is generated between the stationary spring cup 314 and stationary drag plate 310, sandwiching the rotor plate 339. As the rotor plate 339 is operatively connected to the roller cage assembly 110 via the connector plate 340.

Some embodiments include a retaining ring 316 that is used to create a spring cartridge assembly. The spring carriage assembly includes cover 328, spring cup 314, wave spring 312, and retaining ring 316. This is an assembly feature to simplify the assembly process.

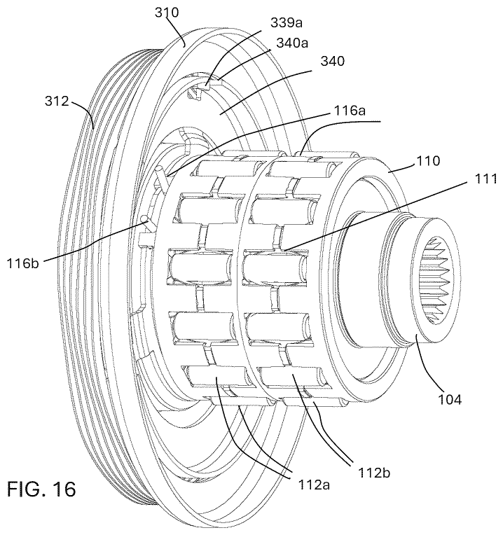

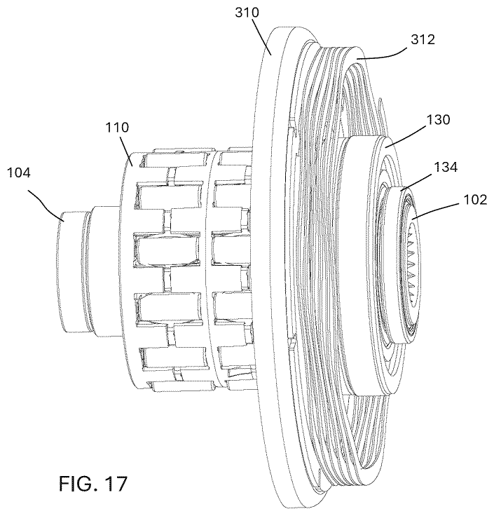

FIG. 16 illustrates the position of wave spring 312 in relation to the connector plate 340 and the roller cage assembly 110. As illustrated, tabs 339a of the rotor plate 339 are received within slots 340a of the connector plate 340 to lock the rotor plate 339 to the connector plate 340. FIG. 16 further illustrates rollers 112a and 112b as well as H-springs 111 of the roller cage assembly 110. FIG. 17 illustrates another view of the wave spring 312, the connector plate 340 and the roller cage assembly 110.

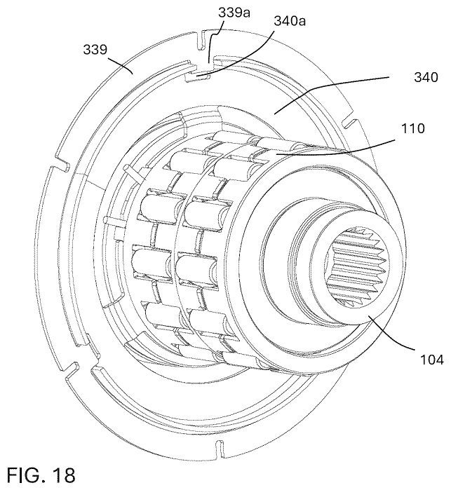

FIG. 18 illustrates the rotor plate 339, the connector plate 340 and the roller cage assembly 110. FIG. 18 further illustrates the tabs 339a of the rotor plate 339 being received within slots 340a of the connector plate 340 to lock the rotor plate 339 to the connector plate 340.

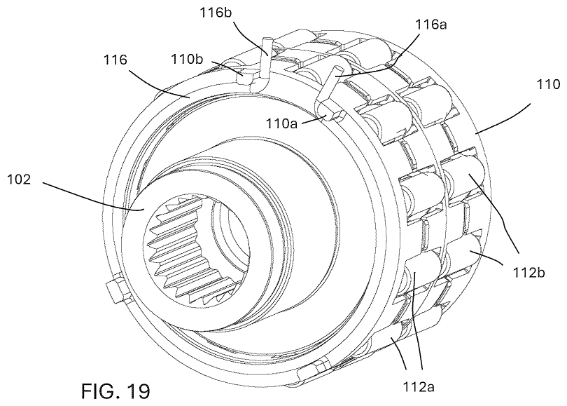

FIG. 19 illustrates the roller cage assembly 110 and the centering spring 116. As illustrated, ends 116a and 116b of the centering spring engage tabs 110a and 110b of the roller cage assembly 110.

Referring to FIG. 20, a vehicle 400 of one example embodiment is illustrated. The vehicle 400 includes a motor 402 to provide engine torque. The motor may be any type of engine that produces engine torque including, but not limited to, internal combustion engines and electrical motors. In this example a continuously variable transmission (CVT 404) is in operational communication with the motor 402. A gear box 406 is further in operational communication with the CVT 404. The gear box 406 may include further gearing such as, but not limited to high, low, reverse, park, etc. A rear prop shaft 408 communicates torque between the gear box 406 and a rear differential 410. Rear wheels 414a and 414b are in operational communication with the rear differential 410 via half shafts 412a and 412b.

The vehicle further includes a front differential 418. The front differential 418 includes an always actuated ORC, such as always actuated ORC 100, always actuated ORC 200, and always actuated ORC 300, as discussed above. The front differential 418 is in operational communication with the gear box 406 via front prop shaft 416. Front wheels 420a and 420b are in communication with the front differential 418 via half shafts 417a and 417b.

### EXAMPLE EMBODIMENTS

Example 1 includes a differential that includes a housing, a cover coupled to the housing, a first side hub and second side hub, a pinion gear, roller cage assembly, a clutch cam housing, a centering spring, and an always actuated ORC. The first and second side hubs are received within the housing. The ring gear is also received within the housing. The pinion gear is in operational engagement with the ring gear. The pinion gear is configured to couple torque between the ring gear and a transmission. The roller cage assembly includes rollers that engage a first roller engaging outer surface portion of the first side hub and a second roller engaging outer surface portion of the second side hub. The clutch cam housing is received around the roller cage assembly. The clutch cam housing is operationally coupled to the ring gear. The clutch cam housing further has an internal surface with cam features. The rollers of the roller cage assembly are positioned to engage the cam features in an interior surface of the clutch cam housing to selectively couple torque between the ring gear and the first and second side hubs. The centering spring is positioned to provide a centering force between the roller cage assembly and the clutch cam housing to center the rollers of the roller cage assembly in associated cam features in the interior surface of the clutch cam housing. The always actuated ORC is configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

Example 2 includes the differential of Example 1, wherein the always actuated ORC further includes at least one drag plate, a rotor plate that is engaged with the roller cage assembly, a connector plate that is engaged with the rotor plate, and at least one spring that is positioned to exert a clamping force on the at least one drag plate and the rotor plate to engage the connector plate.

Example 3 includes the differential of Example 2, further including a plurality of spaced fasteners that are coupled to an inside surface of the cover, each fastener of the plurality of fasteners including a head. The at least one drag plate includes a first drag plate and a second drag plate. The rotor plate is positioned between the first drag plate and the second drag plate. Further wherein the at least one spring includes a spring for each fastener. Each spring is positioned around an associated fastener with a first end abutting the head of the associated fastener and a second end of the spring engaging the second drag plate to exert the clamping force on the at least one drag plate and the rotor plate to engage the connector plate.

Example 4 includes the differential of Example 2, further including a spring cup that is positioned to engage the rotor plate. Further wherein the at least one spring is a single spring. The spring is received within the spring cup. The spring includes a first end that is positioned to engage an inside surface of the cover and a second end to engage an inside surface of the spring cup to exert the clamping force on the at least one drag plate and the rotor plate to engage the connector plate.

Example 5 includes the differential of Example 2, wherein at least one of the at least one drag plate, the rotor plate, and the connector plate is grounded to at least one of the housing and the cover.

Example 6 includes the differential of any of the Examples 1-5, further including a slotted disk spring, a drag plate and a rotor plate. The slotted disk spring includes an outer disk portion that engages a shoulder in the housing. The slotted disk spring further includes a plurality of fingers that extend radially inward from the outer disk portion. Each finger includes a distal end that is axially raised from the outer portion. The rotor plate is engaged with the roller cage assembly. The distal ends of each finger of the slotted disk spring engage the rotor plate to pinch the rotor plate between the fingers and the drag plate.

Example 7 includes the differential of Example 6, wherein the slotted disk spring is grounded to the cover to limit rotation of the slotted disk in relation to the cover.

Example 8 includes the differential of any of the Examples 1-7, further including a first plain bearing end cap and a second plain bearing end cap. The first plain bearing end cap supports a first end portion of the roller cage assembly and the second plain bearing end cap supports a second end portion of the roller cage assembly.

Example 9 includes the differential of Example 8, further wherein the first plain bearing end cap has an interior surface that forms a plain bearing interface with a first end cap engaging surface portion of the first side hub. The first plain bearing end cap further has a first outer surface portion that engages a first end portion of the roller cage assembly. The second plain bearing end cap has an interior surface that forms a plain bearing interface with a second end cap engaging outer surface portion of the second side hub. The second plain bearing end cap further has a first outer surface portion that engages a second end portion of the roller cage assembly. The first and second plain bearing end caps support a positional location of the roller cage assembly.

Example 10 includes a differential including a housing, a cover coupled to the housing, a first side hub, a second side hub, a ring gear received within the housing, a pinion gear, a roller cage assembly, a clutch cam housing, a centering spring, a first plain bearing end cap, a second plain bearing end cap, an always actuated ORC. The first and second side hubs are received within the housing. The pinion gear is in operational engagement with the ring gear. The pinion gear is configured to couple torque between the ring gear and a transmission. The roller cage assembly includes rollers that engage a first roller engaging outer surface portion of the first side hub and a second roller engaging outer surface portion of the second side hub. The clutch cam housing is received around the roller cage assembly. The clutch cam housing is operationally coupled to the ring gear. The clutch cam housing further has an internal surface with cam features. The rollers of the roller cage assembly are positioned to engage the cam features in an interior surface of the clutch cam housing to selectively couple torque between the ring gear and the first and second side hubs. The centering spring is positioned to provide a centering force between the roller cage assembly and the clutch cam housing to center the rollers of the roller cage assembly in associated cam features in the interior surface of the clutch cam housing. The first plain bearing end cap has an interior surface that forms a plain bearing interface with a first end cap engaging outer surface portion of the first side hub. The first plain bearing end cap further has a first outer surface portion that engages a first end portion of the roller cage assembly. The second plain bearing end cap has an interior surface forming a plain bearing interface with a second end cap engaging outer surface portion of the second side hub. The second plain bearing end cap further has a first outer surface portion that engages a second end portion of the roller cage assembly. The first and second plain bearing end caps support a positional location of the roller cage assembly. The always actuated ORC is configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

Example 11 includes the differential of Example 10, wherein the always actuated ORC further includes at least one drag plate, a rotor plate that is engaged with the roller cage assembly, a connector plate that is engaged with the rotor plate and at least one spring. At least one of the at least one drag plate, the rotor plate, and the connector plate is grounded to at least one of the housing and the cover. The at least one spring is positioned to exert a clamping force on the at least one drag plate and rotor plate to engage the connector plate.

Example 12 includes the differential of Example 11, further including a plurality of spaced fasteners that are coupled to an inside surface of the cover. Each fastener of the plurality of fasteners includes a head. The at least one drag plate includes a first drag plate and a second drag plate. The rotor plate is positioned between the first drag plate and the second drag plate. The at least one spring includes a spring for each fastener. Each spring is positioned around an associated fastener with a first end abutting the head of the associated fastener and a second end of the spring engaging the second drag plate to exert the clamping force on the at least one drag plate and rotor plate to engage the connector plate.

Example 13 includes the differential of Example 11, further including a spring cup positioned to engage the rotor plate. The at least one spring is a single spring. The spring is received within the spring cup. The spring includes a first end positioned to engage in inside surface of the cover and a second end to engage an inside surface of the spring cup to exert the clamping force on the at least one drag plate and the rotor plate to engage the connector plate.

Example 14 includes the differential of any of the examples 10-13, further including a slotted disk spring, a drag plate, and a rotor plate. The slotted disk spring includes an outer disk portion that engages a shoulder in the housing. The slotted disk spring further includes a plurality of fingers that extends radially inward from the outer disk portion. Each finger includes a distal end that is axially raised from the outer portion. The rotor plate is engaged with the roller cage assembly. The distal ends of each finger of the slotted disk spring engaging the rotor plate to pinch the rotor plate between the fingers and the drag plate.

Example 15 includes the differential of Example 14, wherein the slotted disk spring is grounded to the cover to limit rotation of the slotted disk in relation to the cover.

Example 16 includes a vehicle. The vehicle includes an engine to generate torque, a CVT, and differential. The CVT is in operational communication with the engine. The differential is in operational engagement with the CVT. The differential includes a housing, a cover coupled to the housing, a first side hub, a second side hub, a ring gear, a pinion gear, a roller cage assembly, a clutch cam housing, a centering spring, and an always activated ORC. The first and second side hubs are received within the housing. The ring gear is received within the housing. The pinion gear is in operational engagement with the ring gear. The pinion gear is configured to couple torque between the ring gear and a transmission. The roller cage assembly includes rollers that engage a first roller engaging outer surface portion of the first side hub and a second roller engaging outer surface portion of the second side hub. The clutch cam housing is received around the roller cage assembly. The clutch cam housing is operationally engaged with the ring gear, the clutch cam housing further have an internal surface with cam features. The rollers of the roller cage assembly are positioned to engage the cam features in an interior surface of the clutch cam housing to selectively couple torque between the ring gear and the first and second side hubs. The centering spring is positioned to provide a centering force between the roller cage assembly and the clutch cam housing to center the rollers of the roller cage assembly in associated cam features in the interior surface of the clutch cam housing. The always actuated ORC is configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

Example 17 includes the vehicle of Example 16, wherein the always actuated ORC further includes at least one drag plate, a rotor plate engaged with the roller cage assembly, a connector plate engaged with the rotor plate, and at least one spring positioned to exert a clamping force on the at least one drag plate and the rotor plate to engage the connector plate.

Example 18 includes the vehicle of Example 17, further including a plurality of spaced fasteners and at least one drag plate. The plurality of spaced fasteners are coupled to an inside surface of the cover. Each fastener of the plurality of fasteners includes a head. The at least one drag plate includes a first drag plate and a second drag plate. The rotor plate is positioned between the first drag plate and the second drag plate. The at least one spring includes a spring for each fastener. Each spring is positioned around an associated fastener with a first end abutting the head of the associated fastener and a second end of the spring engaging the second drag plate to exert the clamping force on the at least one drag plate and the rotor plate to engage the connector plate.

Example 19 includes the vehicle of Examples 17, further including a spring cup that is positioned to engage the rotor plate. The at least one spring is a single spring. The spring is received within the spring cup. The spring includes a first end that is positioned to engage in inside surface of the cover and a second end to engage an inside surface of the spring cup to exert the clamping force on the at least one drag plate and rotor plate to engage the connector plate.

Example 20 includes the vehicle of Example 17, wherein at least one of the at least one drag plate, the rotor plate, and the connector plate is grounded to at least one of the housing and the cover.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

1. A differential comprising:
a housing;
a cover coupled to the housing;
a first side hub;
a second side hub, the first and second side hubs received within the housing;
a ring gear received within the housing;
a pinion gear in operational engagement with the ring gear, the pinion gear configured to couple torque between the ring gear and a transmission;
a roller cage assembly including rollers that engage a first roller engaging outer surface portion of the first side hub and a second roller engaging outer surface portion of the second side hub;
a clutch cam housing received around the roller cage assembly, the clutch cam housing operationally coupled to the ring gear, the clutch cam housing further having an internal surface with cam features, the rollers of the roller cage assembly positioned to engage the cam features in an interior surface of the clutch cam housing to selectively couple torque between the ring gear and the first and second side hubs;
a centering spring positioned to provide a centering force between the roller cage assembly and the clutch cam housing to center the rollers of the roller cage assembly in associated cam features in the interior surface of the clutch cam housing; and
an always actuated overrunning clutch (ORC) configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

2. The differential of claim 1, wherein the always actuated ORC further comprises:
at least one drag plate;
a rotor plate engaged with the roller cage assembly;
a connector plate engaged with the rotor plate; and
at least one spring positioned to exert a clamping force on the at least one drag plate and the rotor plate to engage the connector plate.

3. The differential of claim 2, further comprising:
a plurality of spaced fasteners coupled to an inside surface of the cover, each fastener of the plurality of fasteners including a head;
the at least one drag plate including a first drag plate and a second drag plate, the rotor plate positioned between the first drag plate and the second drag plate; and
wherein the at least one spring includes a spring for each fastener, each spring positioned around an associated fastener with a first end abutting the head of the associated fastener and a second end of the spring engaging the second drag plate to exert the clamping force on the at least one drag plate and the rotor plate to engage the connector plate.

4. The differential of claim 2, further comprising:
a spring cup positioned to engage the rotor plate, wherein the at least one spring is a single spring, the spring being received within the spring cup, the spring including a first end positioned to engage an inside surface of the cover and a second end to engage an inside surface of the spring cup to exert the clamping force on the at least one drag plate and the rotor plate to engage the connector plate.

5. The differential of claim 2, wherein at least one of the at least one drag plate, the rotor plate, and the connector plate is grounded to at least one of the housing and the cover.

6. The differential of claim 1, further comprising:
a slotted disk spring, the slotted disk spring includes an outer disk portion that engages a shoulder in the housing, the slotted disk spring further includes a plurality of fingers that extend radially inward from the outer disk portion, each finger includes a distal end that is axially raised from the outer portion;
a drag plate; and
an rotor plate engaged with the roller cage assembly, the distal ends of each finger of the slotted disk spring engaging the rotor plate to pinch the rotor plate between the fingers and the drag plate.

7. The differential of claim 6, wherein the slotted disk spring is grounded to the cover to limit rotation of the slotted disk in relation to the cover.

8. The differential of claim 1, further comprising:
a first plain bearing end cap supporting a first end portion of the roller cage assembly; and
a second plain bearing end cap supporting a second end portion of the roller cage assembly.

9. The differential of claim 8, further wherein:
the first plain bearing end cap having an interior surface forming a plain bearing interface with a first end cap engaging surface portion of the first side hub, the first plain bearing end cap further having a first outer surface portion that engages a first end portion of the roller cage assembly; and
the second plain bearing end cap having an interior surface forming a plain bearing interface with a second end cap engaging outer surface portion of the second side hub, the second plain bearing end cap further having a first outer surface portion that engages a second end portion of the roller cage assembly, wherein the first and second plain bearing end caps support a positional location of the roller cage assembly.

10. A differential comprising:
a housing;
a cover coupled to the housing;
a first side hub;
a second side hub, the first and second side hubs received within the housing;
a ring gear received within the housing;
a pinion gear in operational engagement with the ring gear, the pinion gear configured to couple torque between the ring gear and a transmission;
a roller cage assembly including rollers that engage a first roller engaging outer surface portion of the first side hub and a second roller engaging outer surface portion of the second side hub;
a clutch cam housing received around the roller cage assembly, the clutch cam housing operationally engaged with the ring gear, the clutch cam housing further having an internal surface with cam features, the rollers of the roller cage assembly positioned to engage the cam features in an interior surface of the clutch cam housing to selectively couple torque between the ring gear and the first and second side hubs;
a centering spring positioned to provide a centering force between the roller cage assembly and the clutch cam housing to center the rollers of the roller cage assembly in associated cam features in the interior surface of the clutch cam housing;
a first plain bearing end cap having an interior surface forming a plain bearing interface with a first end cap engaging outer surface portion of the first side hub, the first plain bearing end cap further having a first outer surface portion that engages a first end portion of the roller cage assembly;
a second plain bearing end cap having an interior surface forming a plain bearing interface with a second end cap engaging outer surface portion of the second side hub, the second plain bearing end cap further having a first outer surface portion that engages a second end portion of the roller cage assembly, wherein the first and second plain bearing end caps support a positional location of the roller cage assembly; and
an always actuated overrunning clutch (ORC) configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

11. The differential of claim 10, wherein the always actuated ORC further comprises:
at least one drag plate;
a rotor plate engaged with the roller cage assembly;
a connector plate engaged with the rotor plate, at least one of the at least one drag plate, the rotor plate, and the connector plate is grounded to at least one of the housing and the cover; and
at least one spring positioned to exert a clamping force on the at least one drag plate and rotor plate to engage the connector plate.

12. The differential of claim 11, further comprising:
a plurality of spaced fasteners coupled to an inside surface of the cover, each fastener of the plurality of fasteners including a head;
the at least one drag plate including a first drag plate and a second drag plate, the rotor plate positioned between the first drag plate and the second drag plate; and
wherein the at least one spring includes a spring for each fastener, each spring positioned around an associated fastener with a first end abutting the head of the associated fastener and a second end of the spring engaging the second drag plate to exert the clamping force on the at least one drag plate and rotor plate to engage the connector plate.

13. The differential of claim 11, further comprising:
a spring cup positioned to engage the rotor plate, wherein the at least one spring is a single spring, the spring being received within the spring cup, the spring including a first end positioned to engage in inside surface of the cover and a second end to engage an inside surface of the spring cup to exert the clamping force on the at least one drag plate and the rotor plate to engage the connector plate.

14. The differential of claim 10, further comprising:
a slotted disk spring, the slotted disk spring includes an outer disk portion that engages a shoulder in the housing, the slotted disk spring further includes a plurality of fingers that extend radially inward from the outer disk portion, each finger includes a distal end that is axially raised from the outer portion;
a drag plate; and
a rotor plate engaged with the roller cage assembly, the distal ends of each finger of the slotted disk spring engaging the rotor plate to pinch the rotor plate between the fingers and the drag plate.

15. The differential of claim 14, wherein the slotted disk spring is grounded to the cover to limit rotation of the slotted disk in relation to the cover.

16. A vehicle comprising:
an engine to generate torque;
a continuously variable transmission (CVT) in operational engagement with the engine; and
a differential in operational communication with the CVT, the differential including,
a housing,
a cover coupled to the housing;
a first side hub,
a second side hub, the first and second side hubs received within the housing;
a ring gear received within the housing,
a pinion gear in operational engagement with the ring gear, the pinion gear configured to couple torque between the ring gear and a transmission;
a roller cage assembly including rollers that engage a first roller engaging outer surface portion of the first side hub and a second roller engaging outer surface portion of the second side hub,
a clutch cam housing received around the roller cage assembly, the clutch cam housing operationally coupled to the ring gear, the clutch cam housing further having an internal surface with cam features, the rollers of the roller cage assembly positioned to engage the cam features in an interior surface of the clutch cam housing to selectively couple torque between the ring gear and the first and second side hubs,
a centering spring positioned to provide a centering force between the roller cage assembly and the clutch cam housing to center the rollers of the roller cage assembly in associated cam features in the interior surface of the clutch cam housing, and
an always actuated overrunning clutch (ORC) configured to engage the roller cage assembly during an ORC condition to provide a torsion force to overcome the centering force provided by the centering spring therein allowing the rollers of the roller cage assembly to selectively couple torque between the ring gear and at least one of the first and second side hubs.

17. The vehicle of claim 16, wherein the always actuated ORC further comprises:
at least one drag plate;
a rotor plate engaged with the roller cage assembly;
a connector plate engaged with the rotor plate; and
at least one spring positioned to exert a clamping force on the at least one drag plate and the rotor plate to engage the connector plate.

18. The vehicle of claim 17, further comprising:
a plurality of spaced fasteners coupled to an inside surface of the cover, each fastener of the plurality of fasteners including a head;
the at least one drag plate including a first drag plate and a second drag plate, the rotor plate positioned between the first drag plate and the second drag plate; and
wherein the at least one spring includes a spring for each fastener, each spring positioned around an associated fastener with a first end abutting the head of the associated fastener and a second end of the spring engaging the second drag plate to exert the clamping force on the at least one drag plate and the rotor plate to engage the connector plate.

19. The vehicle of claim 17, further comprising:
a spring cup positioned to engage the rotor plate, wherein the at least one spring is a single spring, the spring being received within the spring cup, the spring including a first end positioned to engage in inside surface of the cover and a second end to engage an inside surface of the spring cup to exert the clamping force on the at least one drag plate and rotor plate to engage the connector plate.

20. The vehicle of claim 17, wherein at least one of the at least one drag plate, the rotor plate, and the connector plate is grounded to at least one of the housing and the cover.
